(19) United States
(12) Patent Application Publication
(10) Pub. No.: US 2013/0085961 A1
(43) Pub. Date: Apr. 4, 2013

(54) ENTERPRISE CONTEXT VISUALIZATION

(71) Applicants: Rozita Naghshin, Verdun (CA); Thierry Bonfante, Montreal (CA); Abrahim Noor, Dorval (CA)

(72) Inventors: Rozita Naghshin, Verdun (CA); Thierry Bonfante, Montreal (CA); Abrahim Noor, Dorval (CA)

(73) Assignee: Oracle International Corporation, Redwood Shores, CA (US)

(21) Appl. No.: 13/326,580

(22) Filed: Dec. 15, 2011

Related U.S. Application Data
(60) Provisional application No. 61/540,684, filed on Sep. 29, 2011.

(51) Int. Cl. G06Q 10/06

(52) U.S. Cl. 705/348

(57) ABSTRACT

Embodiments of the invention provide systems and methods for providing a contextual visualization of business processes and related business data. According to one embodiment, a method for providing a contextual visualization of business processes and related business data can comprise generating a first canvas representing a first business process. The first canvas can comprise a collaborative, interactive environment accessible to one or more users and can provide access to business data of the first business process to the one or more users. One or more visual objects representing the business data of the first business process can be generated and added to the first canvas. The first canvas with the added one or more visual objects can be provided to the one or more users.

### REFERENCE TO APPENDIX

The present application claims benefit under 35 USC 119(e) of U.S. Provisional Application No. 61/540,684, filed on Sep. 29, 2011 by Naghshin et al and entitled “Enterprise Context Visualization,” of which the entire disclosure is incorporated herein by reference for all purposes.

### BACKGROUND OF THE INVENTION

Embodiments of the present invention relate generally to methods and systems for organizing and presenting information related to ongoing business processes and more particularly to providing a contextual visualization of business processes and related business data.

Any business decision making process highly depends on creating a clear mental model of the business process among all team members. Moreover, understanding a business process depends on understanding the related information, the relationship between the information, the collaborations and discussions around the information, and the evolution of the process and data over time. As a business process becomes more complex, understanding and transferring this kind of knowledge become challenging. It is even more challenging for top executive managers and strategic decision makers who work on different projects simultaneously and collaborating with multiple teams on different processes. Since the processes evolve and the related information changes often, each time the participants switch between projects, they have to rebuild their mental model, which can consume lots of time and effort and may end up with decisions being made on incomplete, misleading, and/or inaccurate information.

Even though current enterprise applications facilitate management of business processes by providing the ability to store, retrieve and manage the business information, none of them provide an effective solution to understand and communicate the in context knowledge created through the process. Most of business applications only address formal collaborations, such as a procurement approval process, where the information passes from one business group to another. However, most collaborations in strategic decision making processes, which can have a huge impact on the future of a company, are ad-hoc and informal involving large number of business participants and managers from different disciplines communicating the business information to create a common ground-knowledge of the context. Social collaborative tools such as Web-2.0 applications try to address this problem, but they do not offer a comprehensive view of the entire context of the business process and related business data. Hence, there is a need for improved methods and systems for organizing and presenting information related to ongoing business processes.

### BRIEF SUMMARY OF THE INVENTION

Embodiments of the invention provide systems and methods for providing a contextual visualization of business processes and related business data. According to one embodiment, a method for providing a contextual visualization of business processes and related business data can comprise generating a first canvas representing a first business process. The first canvas can comprise a collaborative, interactive environment accessible to one or more users and can provide access to business data of the first business process to the one or more users. One or more visual objects representing the business data of the first business process can be generated and added to the first canvas. The first canvas with the added one or more visual objects can be provided to the one or more users, e.g., users with access to the first business process.

In some cases, a second canvas representing a second business process can be generated. The second canvas can comprise a collaborative, interactive environment accessible to one or more users and can provides access to business data of the second business process to the one or more users. One or more visual objects representing the business data of the second business process can be generated and added to the second canvas. The second canvas with the added one or more visual objects can be provided to the one or more users, e.g., users with access to the second business process. For example, the first business process can be related to the second business process. In such cases, providing the first canvas and the second canvas to the one or more users can comprise providing an indication of the relationship between the first business process and the second business process.

In some cases, the one or more visual objects can include a snapshot representation of the business data of the first business process. In such cases, the snapshot can be linked to the business data of the first business process and an update of the snapshot can cause an update of the business data. Additionally or alternatively, the one or more visual objects can include a thumbnail representation of at least a portion of a document related to the first business process. In such cases, the thumbnail can be linked to the document and the document can be opened through the thumbnail.

For example, the one or more visual objects can comprise at least a first visual object representing a first business data object and a second visual object representing a second business data object. In such cases, the first business data object can be related to the second business data object and adding the first visual object and second visual object to the first canvas can comprise adding an indication of the relationship between the first business object and the second business object.

Additionally or alternatively, one of the one or more visual objects can represent a business data object and the business data object can comprise related metadata. In such cases, the visual object includes a representation of at least some of the metadata. In an additional or alternative case, a threaded discussion between two or more of the users can be added to the first canvas and/or the second canvas. The threaded discussion can be related to at least one of the canvas, one or more of the visual object, or a relationship between two or more of the visual objects.

In some cases, a first snapshot can be taken of the first canvas with the added one or more visual objects at a first time. A second snapshot can be taken of the first canvas with the added one or more visual objects at a second time later than the first time. In such cases, a timeline can be presented in the canvas using the first snapshot and the second snapshot. The timeline can represent an evolution of the canvas and the one or more visual objects between the first time and the second time.

According to another embodiment, a system can comprise a processor and a memory communicatively coupled with and readable by the processor. The memory can have stored therein a sequence of instructions which, when executed by the processor, cause the processor to provide a contextual visualization of business processes and related business data by generating a first canvas representing a first business process. The first canvas can comprise a collaborative, interactive environment accessible to one or more users and can provide access to business data of the first business process to the one or more users. One or more visual objects representing the business data of the first business process can be generated and added to the first canvas. The first canvas with the added one or more visual objects can be provided to the one or more users, e.g., users with access to the first business process. A second canvas representing a second business process can be generated. The second canvas can comprise a collaborative, interactive environment accessible to one or more users and can provides access to business data of the second business process to the one or more users. One or more visual objects representing the business data of the second business process can be generated and added to the second canvas. The second canvas with the added one or more visual objects can be provided to the one or more users, e.g., users with access to the second business process. For example, the first business process can be related to the second business process. In such cases, providing the first canvas and the second canvas to the one or more users can comprise providing an indication of the relationship between the first business process and the second business process.

In some cases, the one or more visual objects can include a snapshot representation of the business data of the first business process. In such cases, the snapshot can be linked to the business data of the first business process and an update of the snapshot can cause an update of the business data. Additionally or alternatively, the one or more visual objects can include a thumbnail representation of at least a portion of a document related to the first business process. In such cases, the thumbnail can be linked to the document and the document can be opened through the thumbnail.

According to yet another embodiment, a computer-readable memory can have stored therein a sequence of instructions which, when executed by a processor, cause the processor to provide a contextual visualization of business processes and related business data by generating a first canvas representing a first business process. The first canvas can comprise a collaborative, interactive environment accessible to one or more users and can provide access to business data of the first business process to the one or more users. One or more visual objects representing the business data of the first business process can be generated and added to the first canvas. The first canvas with the added one or more visual objects can be provided to the one or more users, e.g., users with access to the first business process. A second canvas representing a second business process can be generated. The second canvas can comprise a collaborative, interactive environment accessible to one or more users and can provides access to business data of the second business process to the one or more users. One or more visual objects representing the business data of the second business process can be generated and added to the second canvas. The second canvas with the added one or more visual objects can be provided to the one or more users, e.g., users with access to the second business process. For example, the first business process can be related to the second business process. In such cases, providing the first canvas and the second canvas to the one or more users can comprise providing an indication of the relationship between the first business process and the second business process.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating elements of a system for providing contextual visualization according to one embodiment of the present invention.

FIG. 4 is an illustration of a portion of an exemplary user interface for providing context visualization including representations of relationships between objects according to one embodiment of the present invention.

FIG. 5 is an illustration of a portion of an exemplary user interface for providing context visualization including representations of metadata according to one embodiment of the present invention.

FIG. 6 is an illustration of a portion of an exemplary user interface for providing context visualization including a threaded discussion according to one embodiment of the present invention.

FIG. 7 is an illustration of a portion of an exemplary user interface for providing context interoperability including a threaded discussion according to one embodiment of the present invention.

FIG. 8 is an illustration of a portion of an exemplary user interface for providing context visualization including a representation of context evolution according to one embodiment of the present invention.

FIGS. 9A-9C are illustrations of portions of exemplary user interfaces for providing context visualization including a representation of search results according to one embodiment of the present invention.

FIG. 10 is a block diagram illustrating components of a data model for providing context visualization according to one embodiment of the present invention.

FIG. 11 is a flowchart illustrating a process for providing context visualization according to one embodiment of the present invention.

FIG. 12 is a flowchart illustrating a process for updating business data through a context visualization according to one embodiment of the present invention.

FIG. 13 is a flowchart illustrating a process for providing a timeline representation of a context visualization of according to one embodiment of the present invention.

FIGS. 14A and 14B are illustrations portions of exemplary user interfaces for creating context visualization rules according to one embodiment of the present invention.

FIG. 15 is an illustration of an exemplary user interface for applying context visualization rules according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention include systems and methods for providing a contextual visualization of business processes and related business data. More specifically, embodiments of the present invention provide a holistic view of digital information in the context of a business process through a set of visual objects, also referred to herein as visual cards, representing digital information including documents of different formats, semi-structured content, and business data. A visual card can represent, for example, an entire document or a part of a document, and it can also include annotations added by users, metadata associated with the document or business object, etc. These cards can be added to a visualization environment referred to as a visual canvas. The cards can be added to the canvas programmatically, e.g., adding all or some business objects of a particular business process, or manually by users.

According to one embodiment, the visual canvas can also include visualization of relationships between the digital information represented by the visual cards. In some cases, the canvas can render pre-defined relationships between business objects such as the hierarchical relationship between design parts in Product Lifecycle Management. In other cases, the user can create or change relationships manually by grouping visual cards under a pool, or connecting them to other visual cards or business objects. Embodiments can also support nested relationships and the user can easily move or copy a part of the visualization.

Using this contextual visualization presented by the visual canvas and the cards thereon, users can update the workflow of the business process in context. Users also can add markers and tags to objects or relationships represented in the visual canvas. According to one embodiment and depending upon the document or business object represented by the visual cards, the permissions of the user, etc. changes made to the visual cards and/or the relationships represented in the canvas can be saved to the represented objects or documents for further retrieval. Various additional details of embodiments of the present invention will be described below with reference to the figures.

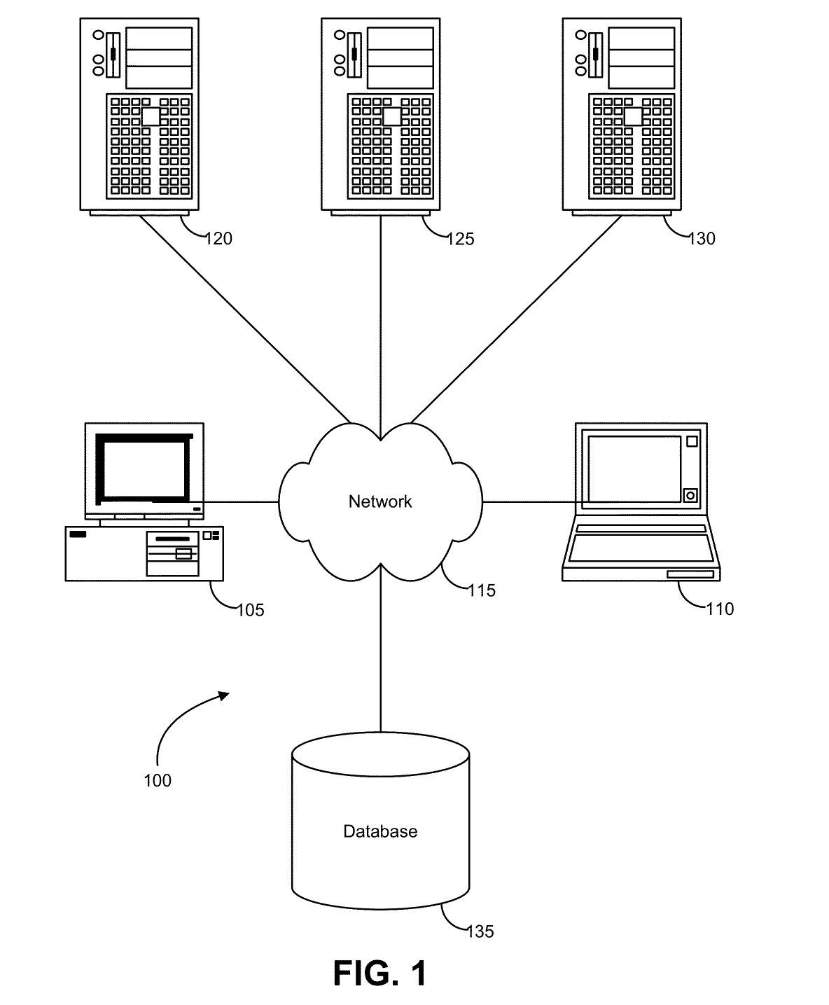

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

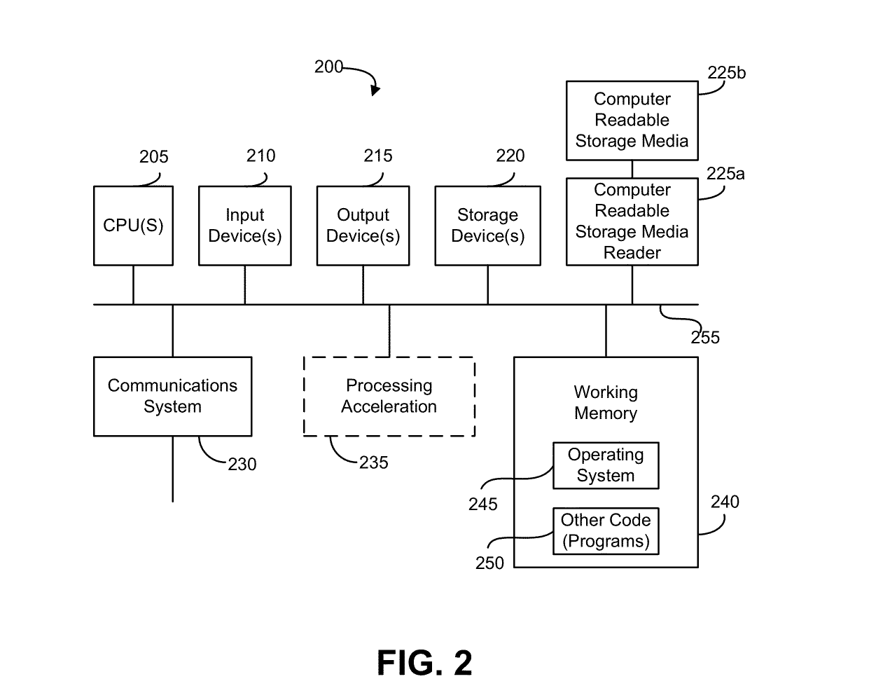

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

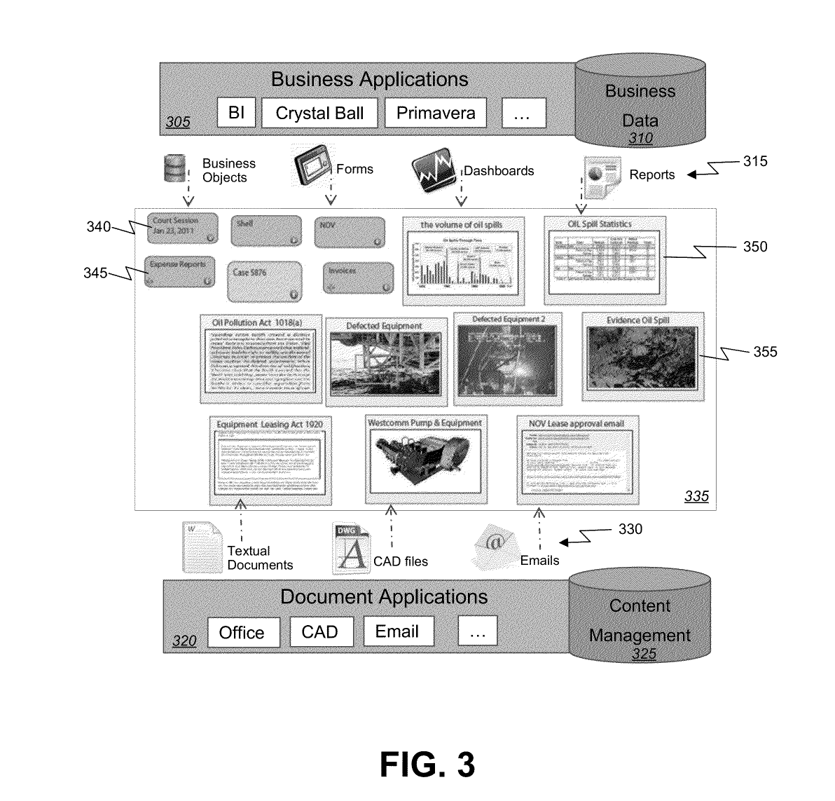

FIG. 3 is a block diagram illustrating elements of a system for providing contextual visualization according to one embodiment of the present invention. As illustrated here, a system, such as one or more servers, clients, and/or other systems as described above, can execute one or more business application 305 and/or document applications 320. For example, the business applications 305 can include, but are not limited to, an enterprise application. The business applications 305 can execute and/or manage any number and variety of business processes such as procurement processes, project management processes, financial processes, etc. The business applications 305 can also maintain a set of business data 310 related to these various business processes. This business data 310 can include any number and variety of different types of business objects 315 such as forms, dashboards, reports, and other types of objects depending upon the business application 305 and process.

Additionally, the same or a different computer system may execute one or more document applications 320. For example, the document applications 320 can include, but are not limited to, an office application suite, a drawing or design application, an email client, etc. Each of these document applications 320 can also maintain a set of content data 325 related to these various applications. This content data 325 can include any number and variety of different types of documents 330 such as textual documents, drawings, emails, and other types of documents depending upon the application 320. These documents 330 can be generated and used by different users and/or groups of users that also participate in the business processes of the business applications 305. Thus, the documents 330 may be related to those processes and may, in different ways, be identified as such. For example, a given document may be identified as related to a business process by the contents of that document, by header information such as a title or subject line, by metadata associated with that document, etc.

As introduced above, embodiments of the invention include systems and methods for providing a contextual visualization of business processes of the business applications 305 and related business data such as the various business objects 315 and documents 330. More specifically, embodiments of the present invention provide a holistic view of digital information in the context of a business process through a set of visual objects 340, 345, 350, and 355 representing the documents 330 and business objects 315. As will be described in greater detail below, a visual object 340, 345, 350, and 355 can represent, for example, an entire document 330 or a part of a document, and it can also include annotations added by users, metadata associated with the document 330 or business object 315, etc. These visual objects 340, 345, 350, and 355 can be added to a visualization environment referred to as a visual canvas 335. As will also be described further below, the visual objects 340, 345, 350, and 355 can be added to the canvas 335 programmatically, e.g., adding all or some business objects of a particular business process, or manually by users.

As will be seen, the visual canvas 335 can include a master canvas and one or more sub-canvases. Generally speaking, a master canvas 335 can comprise a visual area that provides a holistic view of a context of a process of the business application 305. This visual canvas 335 can be automatically created for each process of a business application 305 and made available to users thereof. Sub-canvases (not shown here) can comprise visual areas of the main visual canvas 335 that provide holistic views of the connected business context, e.g., sub-processes, related processes, etc. These canvases can be created for any business workflow, task, internal and external collaboration, project, etc. The sub-canvases, if any, can be nested (ex. a task and sub-tasks) or can be connected (ex. Phase 1, Phase 2, etc. of a design process). The canvas 335 and any sub-canvases can include customized views defined by collaborators of the processes of the business application 305 and related business objects 315 and documents 330.

The visual objects 340, 345, 350, and 355 can include objects 340 and 345 representing the business objects 315 related to a process represented by the canvas 335. These visual objects 340 and 345 can comprise a snapshot of a related business object 315 that may be linked to the original business object 315 so that updates made to the visual object 340 or 345 in the visual canvas 335 can be automatically or manually, i.e., upon request, propagated and saved to the business object 315 represented. The ability of users to view and/or modify visual objects 340 and 345 and the contents of the canvas can be based on their access right in associated business application 305.

The visual objects 340, 345, 350, and 355 can also include objects 350 and 355 representing the documents 330 related to a process represented by the canvas 335.

According to one embodiment, these visual objects 350 and 355 can comprise a thumbnail view of digital information created by users from the documents 330 (in whole or in part). These visual objects 350 and 355 can also include annotations and may be modified by the users. These visual object 350 and 355 can also be linked to the original documents 330 so that updates made to the visual object 350 or 355 in the visual canvas 335 can be automatically or manually, i.e., upon request, propagated and saved to the documents 330 represented. The ability of users to view and/or modify visual objects 350 and 355 and the contents of the canvas 335 can be based on their access right in associated document application 320.

Using this contextual visualization presented by the visual canvas 335 and the visual objects 340, 345, 350, and 355 thereon, users can update the workflow of the business process in context. Users also can add markers and tags to objects 340, 345, 350, and 355 or relationships represented in the visual canvas 335. According to one embodiment and depending upon the document or business object represented by the visual objects 340, 345, 350, and 355, the permissions of the user, etc. changes made to the visual objects 340, 345, 350, and 355 and/or the relationships represented in the canvas can be saved to the represented business objects or documents for further retrieval. That is, collaborators in or on a canvas 335 can comprise users of the business application with access to associated business workflow. Roles of these users within the canvas can be set by an administrator at canvas creation time. The roles and privileges of the users can be enforced both at the canvas and object level. The canvas 335 can support multi-user real time access and provide multiple users the ability to view and navigate the canvas, add to the canvas, modify objects represented thereon, etc.

Thus, embodiments of the present invention can provide a platform agnostic framework for abstracting applications used underneath. The visualizations provided hereby can connect objects and canvases from different business applications to visualize the high level business processes. For example, the user may want to connect an order management canvas in a Customer Relationship Management (CRM) application that contains all customers negotiations to an Order Fulfillment in Supply Chain Management (SCM) application that contains collaboration with suppliers to visualize an order-to-cash work flow. The visualization can also combine structured and unstructured data created by processes or users and represent relationships between those objects. The connections or relationships between objects or canvases can be of different types, e.g., directional, bidirectional, etc. These visualizations can modelize business processes and associated knowledge based on tagging, templates or user created relationships. As will be illustrated in the figures and described below, embodiments of the present invention can provide an intuitive visual interface into the state of a process and its associated knowledge based on user role, current task and access rights. These visualization can support intelligent data exploration via smart tagging and advanced search. Additional details of these processes, the visual canvas 335 and visual objects 340, 345, 350, and 355 will now be described.

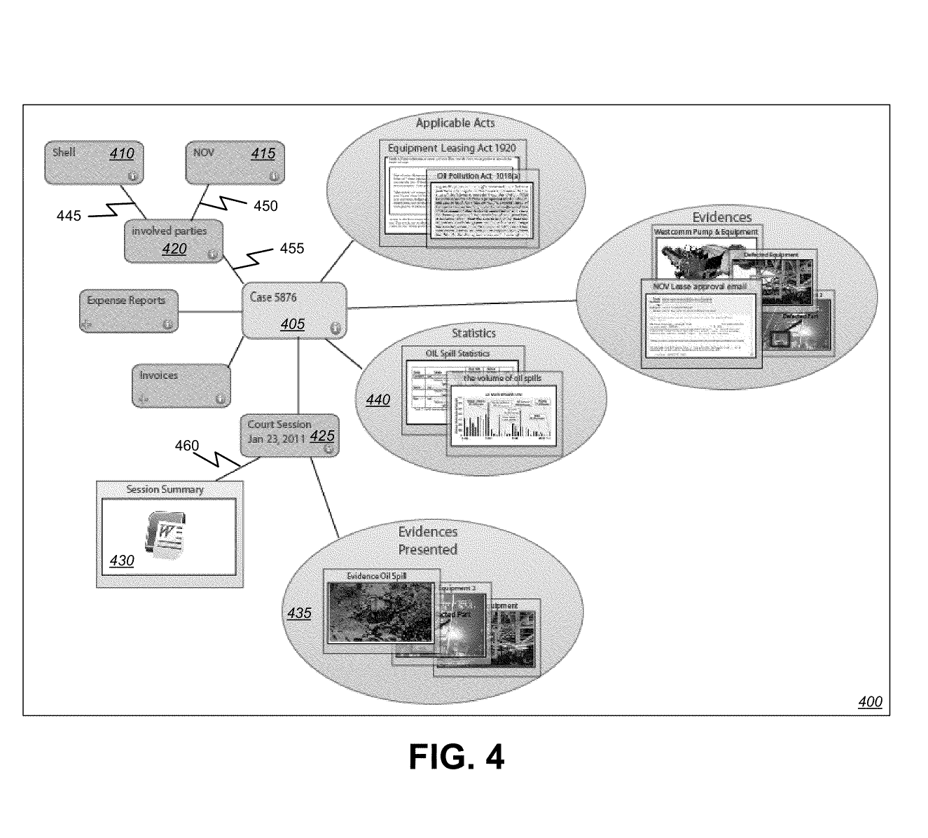

FIG. 4 is an illustration of a portion of an exemplary user interface for providing context visualization including representations of relationships between objects according to one embodiment of the present invention. This example, includes a visual canvas 400 with a visual object 405 representing a process. The visual canvas 400 also includes visual objects 410, 415, 420, and 425 representing business objects related to the business process. Another visual object 430 of the canvas 400 can represent a document. According to one embodiment, the visual canvas 400 can also include visualization of relationships 445, 450, and 455 between the digital information represented by the visual objects 405, 410, 415, and 420. So for example, visual objects 405, 410, 415, and 420 can be arranged and relationships 445, 450, and 455 can be represented to reflect a hierarchy of the business objects represented. In other cases, a relationship 460 can be represented to indicate that a document represented by a visual object 430 is related or tied to a particular business object represented by another visual object 425.

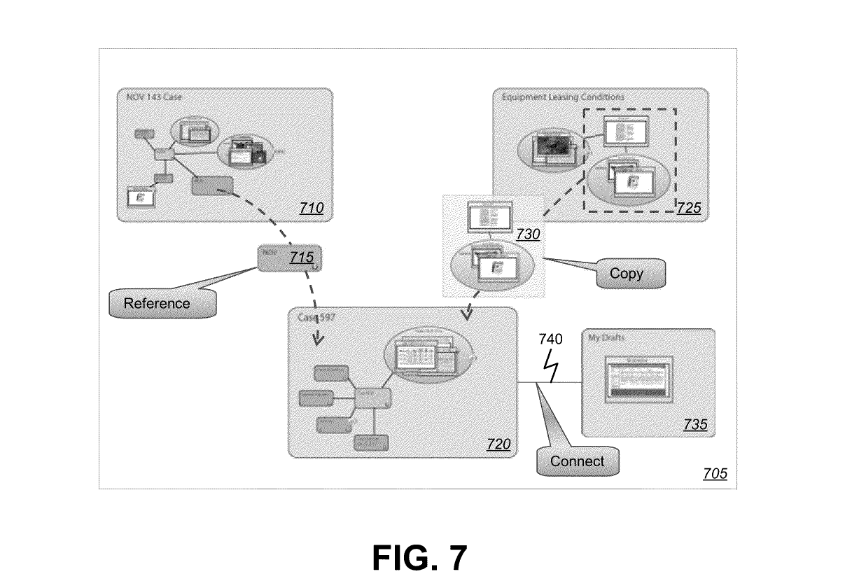

In some cases, the canvas 400 can render pre-defined relationships between business objects such as the hierarchical relationship between business objects, between documents and business objects, etc. In other cases, the user can create or change relationships manually and representing relationships between objects can include grouping visual objects in a pool 435 and 440, or connecting them to other visual objects such as will be described below with reference to FIG. 7. Embodiments can also support nested relationships and the user can easily move or copy a part of the visualization also as will be described below with reference to FIG. 7.

In summary, relationships that can be represented in a visual canvas 400 can include canvas relationships rendering any possible relationship between a main can base and any sub-canvases (nested or connected). Also represented can be business data relationships rendering relationships between business data objects. Any of these relationships can be created by users between visual objects by manipulating the user interface of the visual canvas 400 to indicate direct connections between visual objects, define pools of information, define sequences or hierarchies of objects, etc.

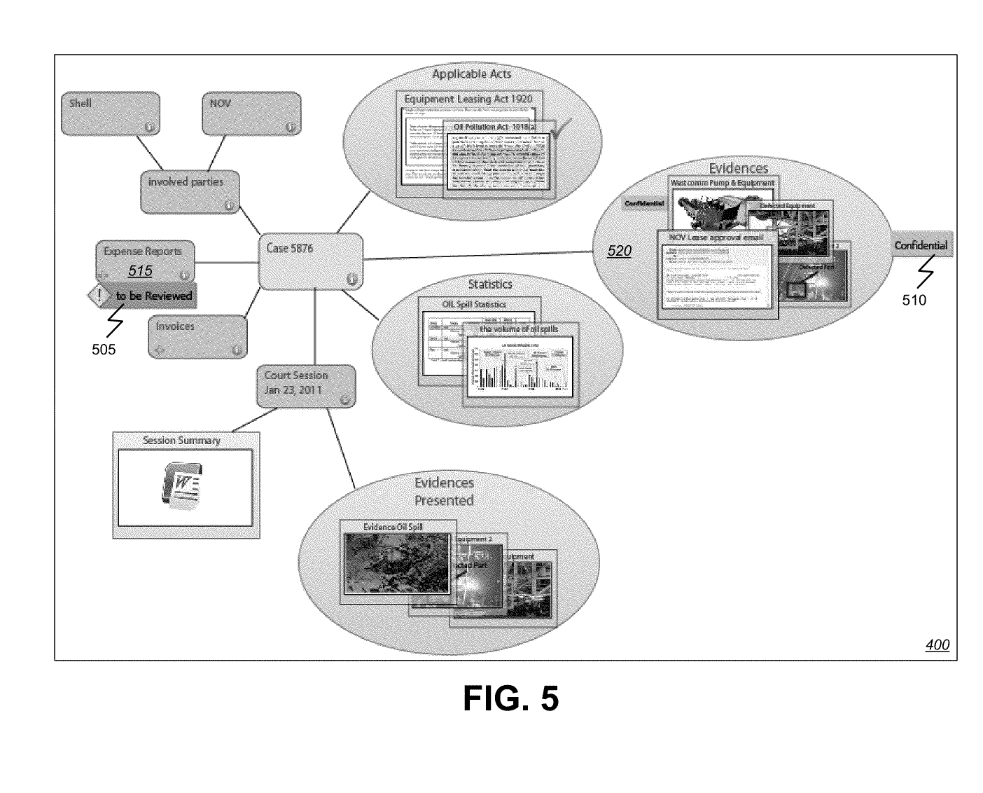

FIG. 5 is an illustration of a portion of an exemplary user interface for providing context visualization including representations of metadata according to one embodiment of the present invention. According to one embodiment, one or more visual objects 515 and 520 represented on the canvas 400 can also include a representation of related metadata 505 and 510, i.e., metadata related to the business object, document, group, etc., represented by the visual object. The related metadata 505 and 510 can comprise status tags, actions, markers, other tags, etc. In some cases, the metadata 505 and 510 can be added or modified by users to the visual objects, relationships, or canvases If added or modified by user, these changes can be reflected in the represented business objects and/or processes, i.e., automatically or manually saved to update the business objects and/or processes represented by the visual objects 515 and 5220 and visual canvas 400. Whether defined as part of the business object, defined by the user, or both, the metadata can be used for further retrieval, e.g., filtering, searching, presenting a customized view, etc.

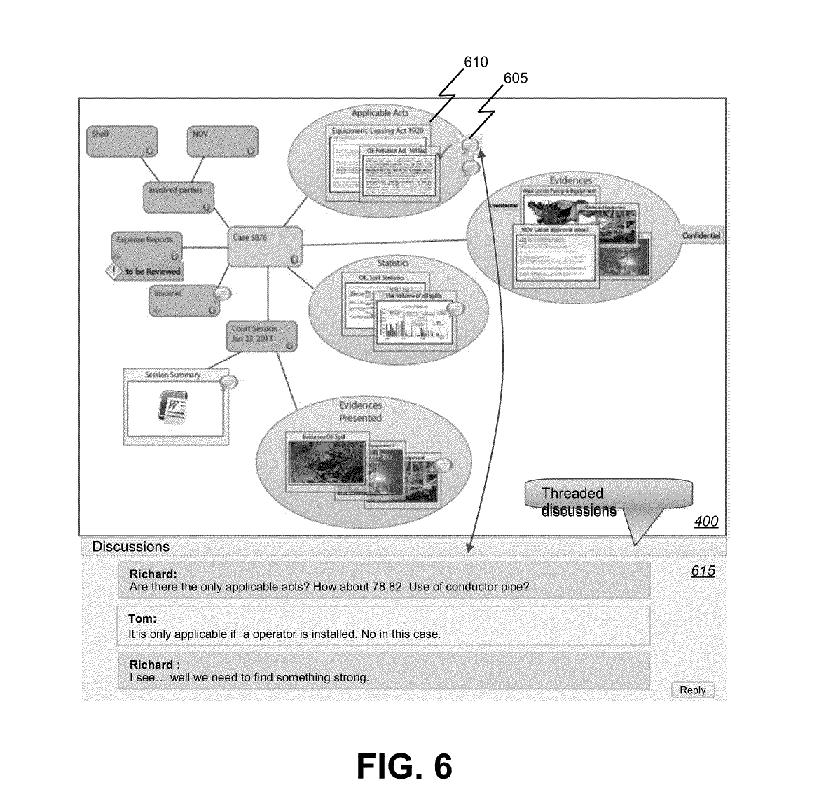

FIG. 6 is an illustration of a portion of an exemplary user interface for providing context visualization including a threaded discussion according to one embodiment of the present invention. According to another embodiment, the visual canvas 400 can also include collaborative threads for the defined context represented by the canvas 400. That is, the canvas 400 can include a threaded discussion 615 between two or more of the users. The threaded discussion 615 can be related to the canvas 400, one or more of the visual object, or a relationship between two or more of the visual objects. For example as illustrated here, the threaded discussion can be related to a group 610 and can be opened or presented/accessed by the user clicking or otherwise selecting an icon 605, button, link, or other indication of the availability of the threaded discussion presented for that visual object. Such threads allow focused discussions between users or subsets of users on precise problem. These users can link discussions to any object in the visual canvas 400, notify collaborators on a certain thread, add metadata e.g., tags and markers, to a discussion, etc. Threaded discussions can also be added as a visual object itself, i.e., added to the canvas 400 rather than added to another visual object 610 as illustrated here.

FIG. 7 is an illustration of a portion of an exemplary user interface for providing context interoperability including a threaded discussion according to one embodiment of the present invention. This example illustrates a visual canvas 705 including an set of sub-canvases 710, 720, 725, and 730. It should be noted that while described here as sub-canvases 710, 720, 725, and 730 from the perspective of viewing the main canvas 705, these can be a canvas 710, 720, 725, and 730 of a process defined in another application. According to one embodiment, the users can manipulate the user interface in which the main visual canvas 705 is presented, e.g., by clicking, highlighting and selecting, dragging and dropping, etc. the sub-canvases 710, 720, 725, and 730 and/or the objects presented therein to modify the processes and objects represented. For example, users can connect 740 one sub-canvas 720 (or other visual object) to another sub-canvas 735 (or other visual object). According to one embodiment, the connection can be viewed by other users that have access to both connected canvases or other objects. In another example, users can add to one of the sub-canvases 720 (or other visual object) a reference 715 to an element of another sub-canvas (or other visual object). In such cases, a visual representation of copied object can be added, e.g., to sub-canvas 720, and the data source, i.e., the original object from sub-canvas 710, can be referenced therefrom. Thus, users can access the original objects based on this copy, e.g., can open the document of object if the user has access right. In yet another example, an object or group of objects 730 can be copied from one canvas to another 720. In this case, the data source, e.g., a selected group of objects 730, can be copied to a target sub-canvas 720, group, etc.

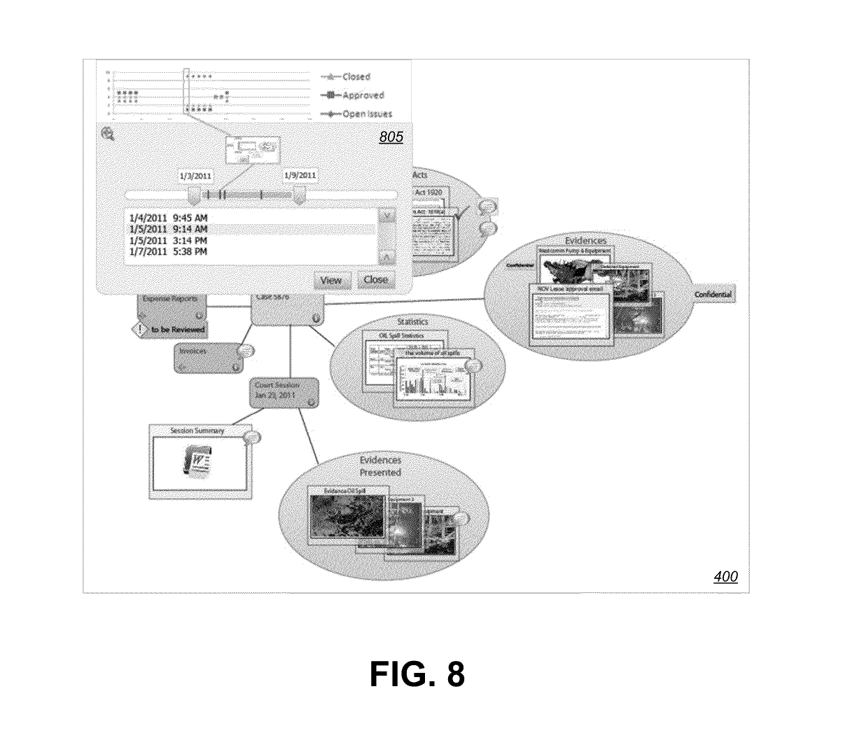

FIG. 8 is an illustration of a portion of an exemplary user interface for providing context visualization including a representation of context evolution according to one embodiment of the present invention. As the users manipulate the canvas and the objects represented thereon, the process, business objects, documents, etc. change and evolve. This evolution can be captured by taking a series of snapshots of the canvas, e.g., periodically over time, upon request by the users, at the end of a user session, upon completion of a modification, some combination thereof, etc. These snapshots can be used to present a timeline 805 of the process and related objects and documents through which this evolution can be presented. For example, using this timeline, the users can go back in time, e.g., select a time represented in the timeline 805, which can cause the canvas 400 to be updated to display the canvas and visual objects saved at or near the selected time.

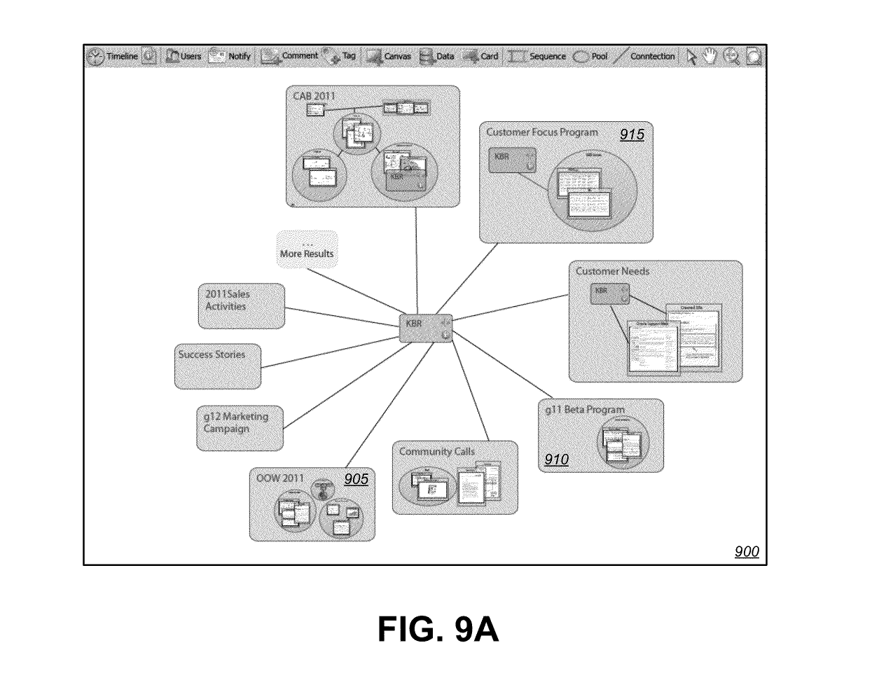

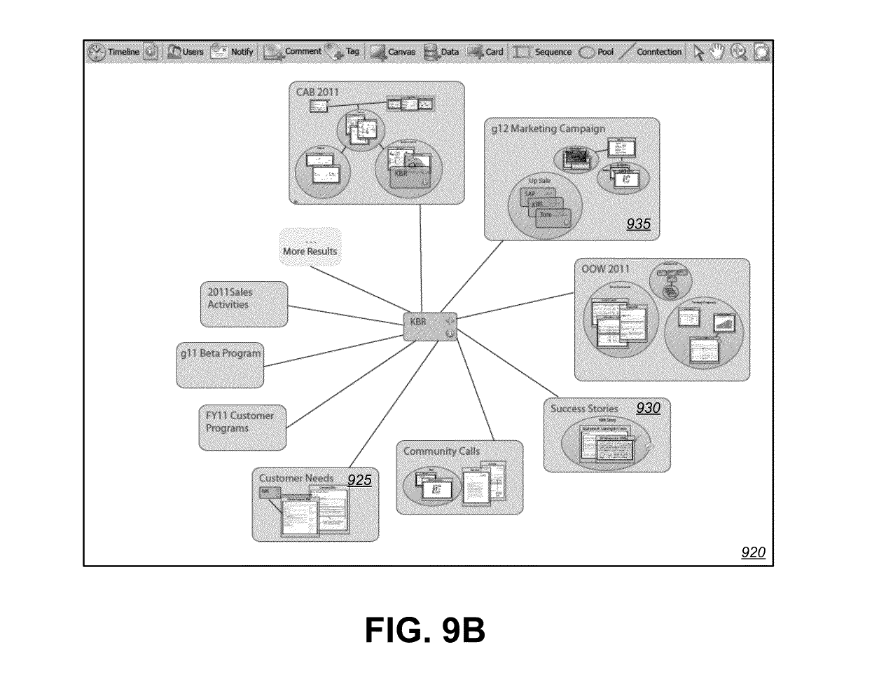

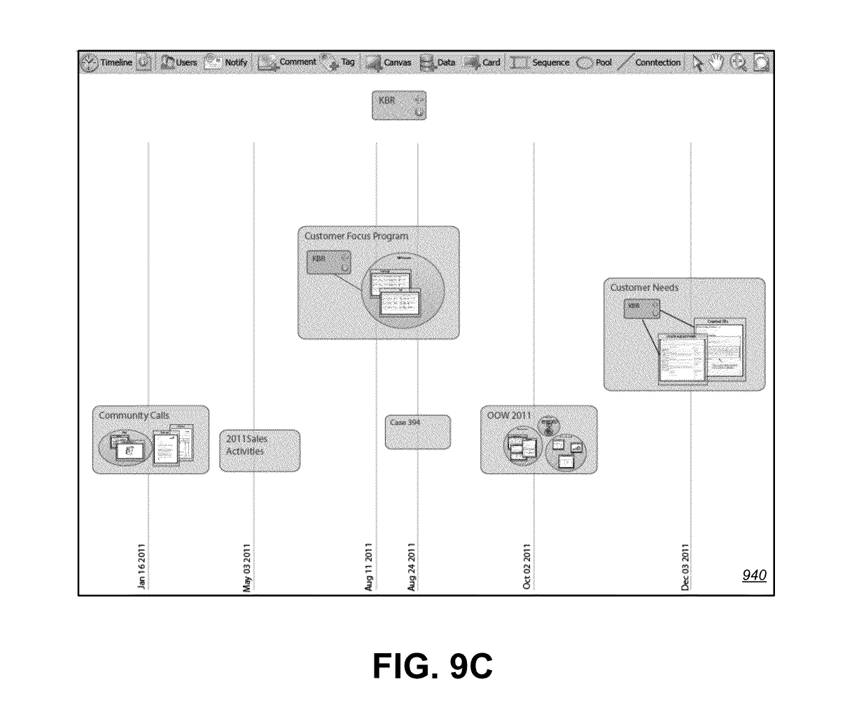

FIGS. 9A-9C are illustrations of portions of exemplary user interfaces for providing context visualization including a representation of search results according to one embodiment of the present invention. According to one embodiment, users can search across contexts, i.e., across processes etc., and/or can filter search results based on contexts. Based on such searches, the users can also view and compare different contexts side by side. In the contextual search the user typically searches for tags, business objects or documents. As illustrated by FIG. 9A, the system can then show the users canvases/business processes, e.g., 905, 910, and 915 that include the associated data. For example, if the user searches for customer “KBR” the system can show canvases in which KBR is included. As illustrated by FIGS. 9A and 9B, the system can sort results 900 and 920 based on different attributes such as user's role. For example, the search results can be different for a marketing manager, as illustrated by results 920 of FIG. 9B, and product manager, as illustrated by results 900 of FIG. 9A. According to one embodiment, results can be sorted by date and/or time and, as illustrated by FIG. 9C, the sorted or ordered results 940 can be presented in this order, for example along a timeline.

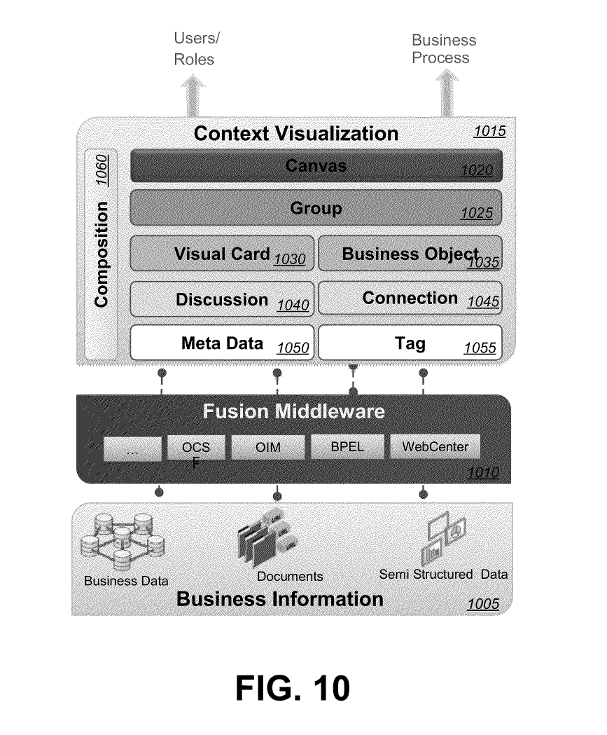

FIG. 10 is a block diagram conceptually illustrating components of a data model for providing context visualization according to one embodiment of the present invention. As illustrated here, various types of business information 1005 including but not limited to business data, documents, semi-structured data, etc., can be maintained and accessed through various middleware 1010 applications as known in the art. According to one embodiment, a visualization 1015 of the business information 1005 can be implemented on or through the middleware 1010. As described above, the visualization 1015 can include a canvas 1020 comprising a visual area that provides a holistic view of the business information 1005 and processes. The context visualization 1015 can also comprise one or more groups 1025 that can identify subsets of digital information which can, in some cases, be ordered. A visual card 1030 can comprise a snapshot of unstructured or semi-structured data while business objects 1035 can comprise snapshot of structured data. Also as described above, the visualization 1015 in this model can include one or more discussions 1040. Connections 1045, e.g., directional relationship between entities can also be represented. MetaData 1050 can comprise related data from application process (e.g. status, state etc.) while tags 1055 can comprise labels and markers provided by users of the visualization 1015. Composition 1060 can be used to represent time-based parent/child relationships between entities (nested relationships).

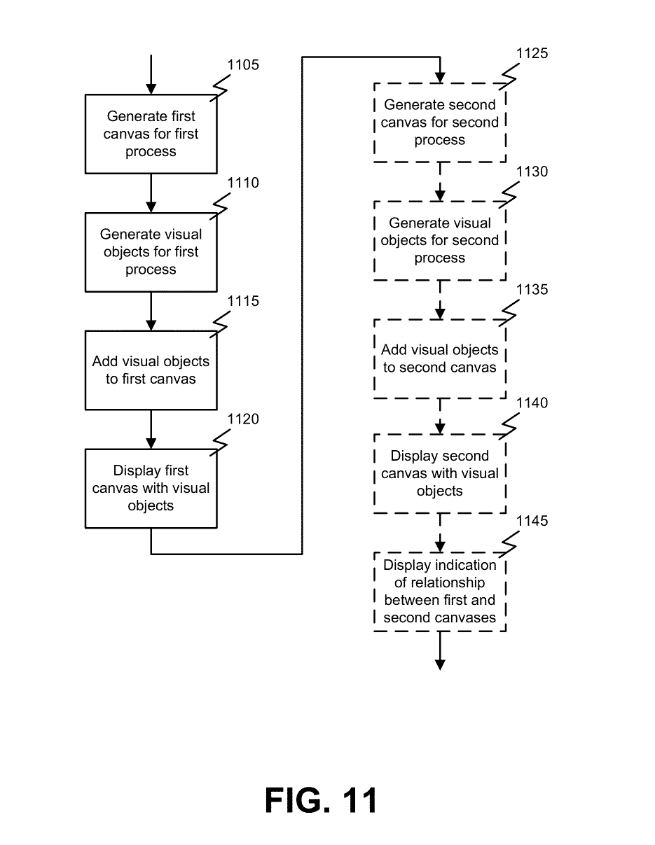

FIG. 11 is a flowchart illustrating a process for providing context visualization according to one embodiment of the present invention. More specifically, this figure illustrates an example of a process for rendering a visual canvas and visual objects as described above for representing a business process and business objects and/or documents related thereto. In this example, providing a contextual visualization of business processes and related business data can begin with generating 1105 a first canvas representing a first business process. As noted above, the first canvas can comprise a collaborative, interactive environment accessible to one or more users and can provide access to business data of the first business process to the one or more users. One or more visual objects representing the business data of the first business process can be generated 1110 and added 1115 to the first canvas. Generating the visual canvas and the visual objects for the various documents and/or business objects can be based, for example, on a business process definition or other set of code or definitions of the enterprise application or other application managing the process. The first canvas with the added one or more visual objects can be provided 1120 to the one or more users.

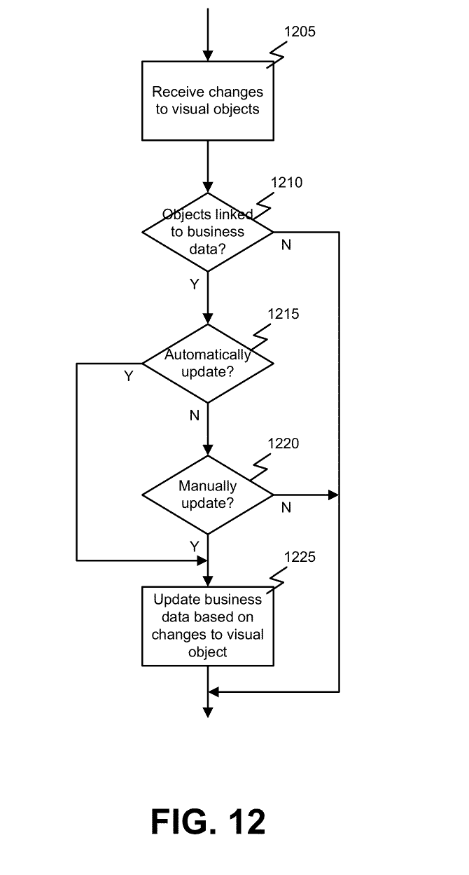

Optionally, the process can further comprise presenting additional canvases representing sub-processes of the first business process, separate but related processes to the first business process, or even unrelated business processes. In such cases, the process can optionally continue with generating 1125 a second canvas representing the second business process. One or more visual objects representing the business data of the second business process can be generated and added 1135 to the second canvas. The second canvas with the added one or more visual objects can be provided 1140 to the one or more users. If the second business process is related to the first business process in some way, e.g., as a sub process or other relationship, this relationship can also be represented 1145 when displaying the second canvas. Once displayed, the user may manipulate the visual objects of the canvases to affect the data and/or the relationships between the documents, business objects and/or the business processes as described above. If the visual objects are linked to the represented documents and/or objects, these changes may be saved to update the documents and/or objects as will be described with reference to FIG. 12.

It should be noted that context visualization can also provide visualization across application business processes. In this case, embodiments could provide abstraction of the overall business process regardless of technical application. As an example, a visualization can be provided for an “Order to Cash” workflow which may include: 1. Lead to opportunity process provided by CRM (Consumer Relationship management); 2. Opportunity to Order provided by CRM; 3. Order Fulfillment provided by SCM (Supply Chain Management); and 4. Payment and Collection provided by Financial Application. The users can view the entire process, zoom into a sub process, and zoom into a canvas related to a single process.

FIG. 12 is a flowchart illustrating a process for updating business data through a context visualization according to one embodiment of the present invention. In this example, the process can begin with receiving 1205 indications of changes to the visual objects. For example, these changes can comprise the user adding or removing visual elements to the canvas, changing metadata or contents of a visual object, adding, changing, or deleting relationships between objects, updating a status or other attribute of the process, etc.

A determination 1210 can be made as to whether the affected visual objects are linked to the documents and/or business objects they represent. If a determination 1210 is made that the changed visual objects are linked to the documents and/or business objects they represent, updates to those documents or objects can be made automatically or manually. For example, a determination 1215 can be made as to whether the updates should be made automatically. This determination 1215 can be based, for example, on a setting or preference for the user, on a default value or setting for one or more of the visual canvas and/or the visual objects, or on other criteria or conditions. If the determination 1215 is made that the documents or objects should be updated automatically, the changes can be saved to the original document or object to which the visual object is linked.

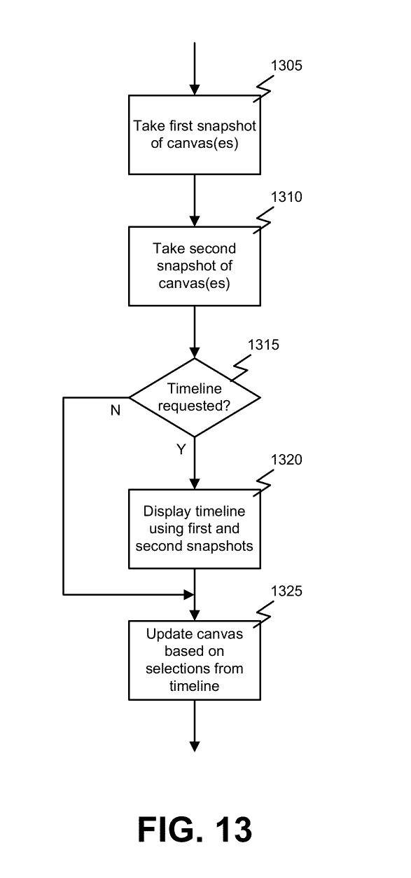

If a determination 1215 is made that the documents or objects should not be updated automatically, another determination 1220 can be made as to whether the documents or objects should be updated manually. This determination 1220 can be based, for example, on querying the user by presenting a popup or other message to confirm the changes and/or on the user clicking or selecting a link, button, icon, or other control from a message, menu, toolbar etc. If the determination 1220 is made that the documents or objects should be updated manually, the changes can be saved to the original document or object to which the visual object is linked. As these changes are made over time, the canvas can be periodically captured and saved, as will be described below with reference to FIG. 13, so that a representation of the evolution of the business process over time can be made.

FIG. 13 is a flowchart illustrating a process for providing a timeline representation of a context visualization of according to one embodiment of the present invention. In this example, the process can begin with taking 1305 a first snapshot of the visual canvas with the visual objects at a first time and taking 1310 a second snapshot of the visual canvas with the visual objects at a second time later than the first time. These snapshots can be taken, for example, based upon a predetermined interval. If 1315 or upon a request from the user, e.g., upon selection of a link, button, icon, etc in the user interface, the first a timeline can be presented using the first snapshot and the second snapshot. The timeline can represent an evolution of the first canvas and the one or more visual objects between the first time and the second time. The user can select a time, e.g., by moving a slider control, clicking or selecting a date and/or time from a calendar or other representation of the timeline, etc., and the canvas can correspondingly be updated 1325 to reflect the conditions of the business process at that time. That is, for example, upon selection of a date or time near the time at which the first snapshot was taken, the canvas can be updated to show the first snapshot.

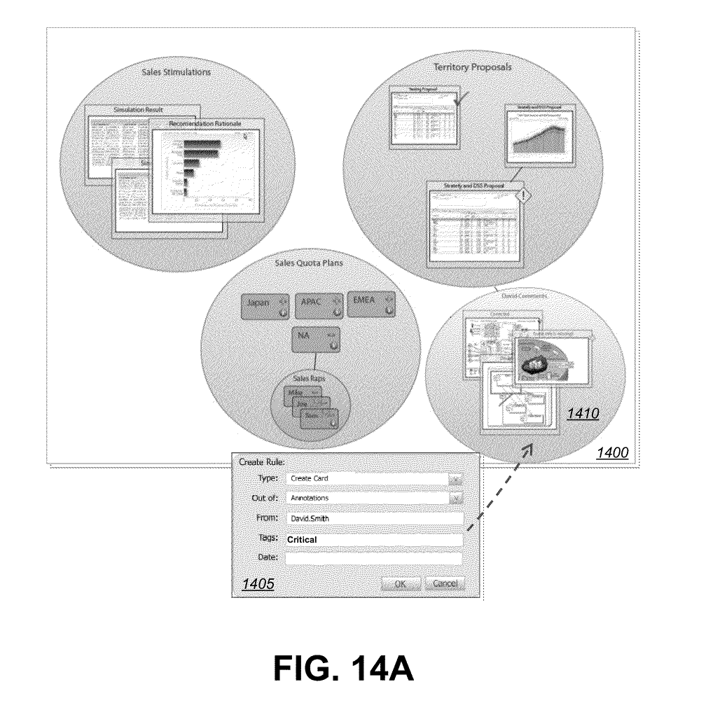

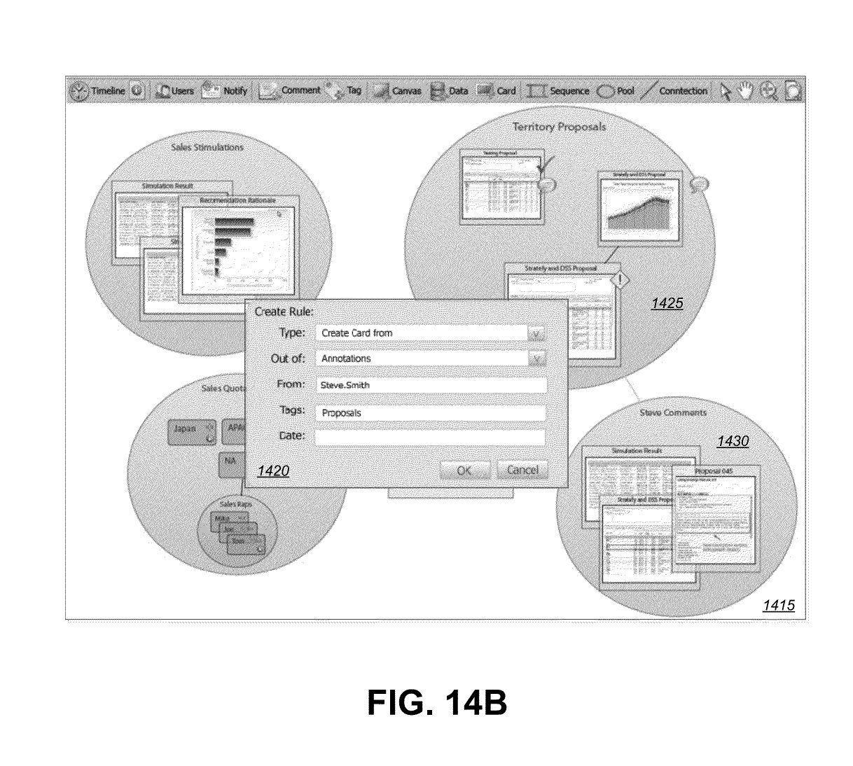

FIGS. 14A and 14B are illustrations portions of exemplary user interfaces for creating context visualization rules according to one embodiment of the present invention. According to one embodiment and as illustrated by FIG. 14A, an interface 1400 can be provided through which rules can be defined to provide a more intelligent visualization of a context. For example, a dialog 1405 or other element may be opened, for example by a user clicking or otherwise selecting a canvas 1410 or other object of the interface 1400. Through this dialog 1405, a user can define rules to be applied to the presentation of visualization of this canvas 1410 or object. For example, rules can be applied to cause a visual highlight of information that needs user' attention. In another example, a template or rule set can be created to enforce corporate best practices (users can apply templates to any canvases).

According to one embodiment and as illustrated in FIG. 14B, an interface 1415 can be provided through which rules can be defined for relationships between objects. For example, a dialog 1420 or other element may be opened, for example by a user clicking or otherwise selecting a relationship between one or more objects 1425 and 1430 visualized in the interface 1415. Through this dialog 1405, a user can define rules to be applied to the presentation of visualization of this relationship.

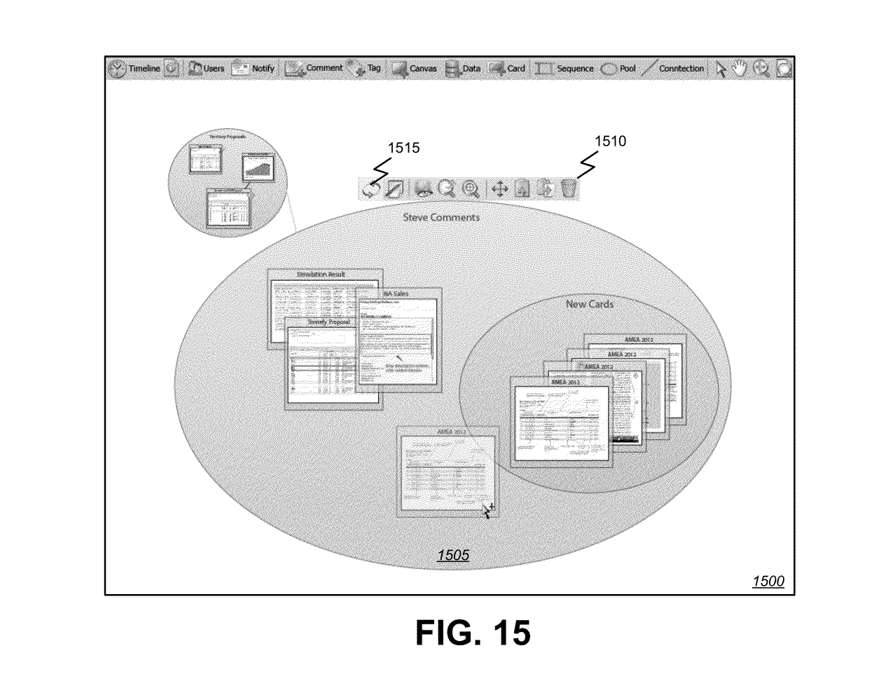

FIG. 15 is an illustration of an exemplary user interface for applying context visualization rules according to one embodiment of the present invention. This example illustrates an interface 1500 through which results of application of rules for a particular object 1505 can be presented. Additionally, in some cases, a toolbar 1510 or menu can be presented. For example, this toolbar can include a number of icons such as an icon 1515 for refreshing or applying the rules to the object 1505. Upon a selection of this icon, e.g., via a mouse click, keyboard stroke, etc., the rules defined as described above can be applied and the visualization of the object 1505 can be updated accordingly, e.g., to cause a visual highlight of information that needs user' attention. etc.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for providing a contextual visualization of business processes and related business data, the method comprising:
generating a first canvas representing a first business process, wherein the first canvas comprises a collaborative, interactive environment accessible to one or more users and wherein the first canvas provides access to business data of the first business process to the one or more users;
generating one or more visual objects representing the business data of the first business process;
adding the one or more visual objects representing the business data of the first business process to the first canvas; and
providing the first canvas with the added one or more visual objects to the one or more users.

2. The method of claim 1, further comprising:
generating a second canvas representing a second business process, wherein the second canvas comprises a collaborative, interactive environment accessible to one or more users and wherein the second canvas provides access to business data of the second business process to the one or more users;
generating one or more visual objects representing the business data of the second business process;
adding the one or more visual objects representing the business data of the second business process to the second canvas; and
providing the second canvas with the added one or more visual objects to the one or more users.

3. The method of claim 2, wherein the first business process is related to the second business process and wherein providing the first canvas and the second canvas to the one or more users comprises providing an indication of the relationship between the first business process and the second business process.

4. The method of claim 1, wherein the one or more visual objects include a snapshot representation of the business data of the first business process.

5. The method of claim 4, wherein the snapshot is linked to the business data of the first business process and wherein an update of the snapshot causes an update of the business data.

6. The method of claim 1, wherein the one or more visual objects include a thumbnail representation of at least a portion of a document related to the first business process.

7. The method of claim 6, wherein the thumbnail is linked to the document and wherein the document can be opened through the thumbnail.

8. The method of claim 1, wherein the one or more users comprise users with access to the first business process.

9. The method of claim 1, wherein the one or more visual objects comprise at least a first visual object representing a first business data object and a second visual object representing a second business data object, wherein the first business data object is related to the second business data object and wherein adding the first visual object and second visual object to the first canvas comprises adding an indication of the relationship between the first business object and the second business object.

10. The method of claim 1, wherein at least one of the one or more visual objects represents a business data object, wherein the business data object comprises related metadata, and wherein the visual object includes a representation of at least some of the metadata.

11. The method of claim 1, further comprising adding to the first canvas a threaded discussion between two or more of the users, wherein the threaded discussion is related to at least one of the first canvas, one or more of the visual object, or a relationship between two or more of the visual objects.

12. The method of claim 1, further comprising:
taking a first snapshot of the first canvas with the added one or more visual objects at a first time;
taking a second snapshot of the first canvas with the added one or more visual objects at a second time later than the first time; and
presenting in the first canvas a timeline using the first snapshot and the second snapshot, wherein the timeline represents an evolution of the first canvas and the one or more visual objects between the first time and the second time.

13. A system comprising:
a processor; and
a memory communicatively coupled with and readable by the processor an having stored therein a sequence of instructions which, when executed by the processor, cause the processor to provide a contextual visualization of business processes and related business data by:
generating a first canvas representing a first business process, wherein the first canvas comprises a collaborative, interactive environment accessible to one or more users and wherein the first canvas provides access to business data of the first business process to the one or more users;
generating one or more visual objects representing the business data of the first business process;
adding the one or more visual objects representing the business data of the first business process to the first canvas;
providing the first canvas with the added one or more visual objects to the one or more users
generating a second canvas representing a second business process, wherein the second canvas comprises a collaborative, interactive environment accessible to one or more users and wherein the second canvas provides access to business data of the second business process to the one or more users;
generating one or more visual objects representing the business data of the second business process;
adding the one or more visual objects representing the business data of the second business process to the second canvas; and
providing the second canvas with the added one or more visual objects to the one or more users.

14. The system of claim 13, wherein the first business process is related to the second business process and wherein providing the first canvas and the second canvas to the one or more users comprises providing an indication of the relationship between the first business process and the second business process.

15. The system of claim 13, wherein the one or more visual objects include a snapshot representation of the business data of the first business process, wherein the snapshot is linked to the business data of the first business process, and wherein an update of the snapshot causes an update of the business data.

16. The system of claim 13, wherein the one or more visual objects include a thumbnail representation of at least a portion of a document related to the first business process, wherein the thumbnail is linked to the document, and wherein the document can be opened through the thumbnail.

17. A computer-readable memory having stored therein a sequence of instructions which, when executed by a processor, cause the processor to provide a contextual visualization of business processes and related business data by:
generating a first canvas representing a first business process, wherein the first canvas comprises a collaborative, interactive environment accessible to one or more users and wherein the first canvas provides access to business data of the first business process to the one or more users;
generating one or more visual objects representing the business data of the first business process;
adding the one or more visual objects representing the business data of the first business process to the first canvas;
providing the first canvas with the added one or more visual objects to the one or more users
generating a second canvas representing a second business process, wherein the second canvas comprises a collaborative, interactive environment accessible to one or more users and wherein the second canvas provides access to business data of the second business process to the one or more users;
generating one or more visual objects representing the business data of the second business process;
adding the one or more visual objects representing the business data of the second business process to the second canvas; and
providing the second canvas with the added one or more visual objects to the one or more users.

18. The computer-readable memory of claim 17, wherein the first business process is related to the second business process and wherein providing the first canvas and the second canvas to the one or more users comprises providing an indication of the relationship between the first business process and the second business process.

19. The computer-readable memory of claim 17, wherein the one or more visual objects include a snapshot representation of the business data of the first business process, wherein the snapshot is linked to the business data of the first business process, and wherein an update of the snapshot causes an update of the business data.

20. The computer-readable memory of claim 17, wherein the one or more visual objects include a thumbnail representation of at least a portion of a document related to the first business process, wherein the thumbnail is linked to the document, and wherein the document can be opened through the thumbnail.
